(19) United States
(12) Patent Application Publication
(10) Pub. No.: US 2023/0384758 A1
(43) Pub. Date: Nov. 30, 2023

(54) INTEGRATED SYSTEM FOR CUSTOMIZED MACHINE TOOL DETECTION

(71) Applicant: TECOM CO., LTD., Hsin-Chu (TW)

(72) Inventor: Kuo-Chuan HUNG, Hsin-Chu (TW)

(21) Appl. No.: 17/845,139

(22) Filed: Jun. 21, 2022

(30) Foreign Application Priority Data
May 24, 2022 (TW) 111119318

(51) Int. Cl. G05B 19/4065

(52) U.S. Cl. CPC G05B 19/4065; G05B 2219/35519

(57) ABSTRACT

An integrated system for customized machine tool detection is disclosed in the present invention. The integrated system includes a communication module, a database, a display module, an operation interface, and an integrated module. The integrated system for customized machine tool detection is utilized to save a plurality of machine tool detection sub-systems with a first protocol, make a user choose at least one machine tool detection sub-systems to be a customized machine tool detection system to detect a working machine tool.

### CROSS-REFERENCE TO RELATED APPLICATION

This application claims the priority benefit of Taiwan application serial No. 111119318, filed on May 24, 2022. The entirety of the above-mentioned patent application is hereby incorporated by reference herein and made a part of the specification.

### BACKGROUND OF THE INVENTION

### Field of the Invention

The present invention is related to a system, and more particularly is related to an integrated system for customized machine tool detection.

### Description of the Related Art

A machine tool is known as the mother of mechanism, which is an indispensable part of manufacturing. Generally, the machine driven by power, cannot be carried by human, for machining objects by a combination of physical, chemical or other ways of deformations, such as cutting and stamping, can be regarded as a machine tool.

Take the stamping tool for example, the prior art uses scheduled maintenance inspection or does maintenance until the stamping tool is damaged. In more detail, the maintenance cycle of the mold of the stamping tool would be estimated using past experience, or the maintenance is carried out until discovering the mold is in poor condition or the stamped product is in poor condition.

However, do the maintenance until damage happens or scheduled maintenance inspection may cause the problems such as unexpected stop of production line, excessive maintenance, failure to maintain, relying on human experience, premature maintenance of the mold leading to shortened life, or poor finished products. Therefore, there is room for improvement in the prior art.

### BRIEF SUMMARY OF THE INVENTION

In view of the prior art, do the maintenance until damage happens or the scheduled maintenance inspection may cause unexpected stop of production line, excessive maintenance, failure to maintain, relying on human experience, premature maintenance of mold leading to shortened life, poor finished products, or other problems derived thereof. It is an object of the present invention to provide an integrated system for customized machine tool detection to resolve at least one problem of the prior art.

An integrated system for customized machine tool detection is provided for resolving the prior art problems. The integrated system for customized machine tool detection comprises a communication module, a database, a display module, an operation interface, and an integrated module. The communication module has a first communication protocol interface. The database is used for storing a plurality of machine tool detection sub-systems sharing the first communication protocol interface and is communicated with the communication module. The display module is communicated with the database and shows a plurality of sub-system items corresponding to the plurality of machine tool detection sub-systems. The operation interface is communicated with the communication module, for a user to choose at least one of the plurality of sub-system items as at least one to-be-integrated sub-system item based on at least one detection request of a working machine tool, wherein the at least one machine tool detection sub-system corresponding to the at least one to-be-integrated sub-system item is defined as at least one to-be-integrated machine tool detection sub-system. The integrated module is communicated with the operation interface for using the first communication protocol interface to integrate the corresponding at least one to-be-integrated machine tool detection sub-system according to the chosen at least one to-be-integrated sub-system item as a customized machine tool detection system satisfying the at least one detection request for detecting the working machine tool to access a detection information.

In accordance with an embodiment of the present invention, the first communication protocol interface of the integrated system for customized machine tool detection further comprises a share database field.

In accordance with an embodiment of the present invention, the first communication protocol interface of the integrated system for customized machine tool detection is a HTTP POST interface.

In accordance with an embodiment of the present invention, the first communication protocol interface of the integrated system for customized machine tool detection is a HTTP GET interface.

In accordance with an embodiment of the present invention, the integrated system for customized machine tool detection further comprises an added detection sub-system, an added communication module and a conversion module. The added communication module has a second communication protocol interface which is different from the first communication protocol interface and is communicated with the added detection sub-system. The conversion module is communicated with the added communication module and the database, for having the added detection sub-system using the second communication protocol interface interfaces with the database.

In accordance with an embodiment of the present invention, the conversion module of the integrated system for customized machine tool detection is a translator.

In accordance with an embodiment of the present invention, the second communication protocol interface of the integrated system for customized machine tool detection is a MODBUS TCP interface.

In accordance with an embodiment of the present invention, the plurality of machine tool detection sub-systems of the integrated system for customized machine tool detection at least comprises a mold detection sub-system, wherein the mold detection sub-system is used for detection detecting a mold and has the detection information includes a mold vibration acceleration value.

In accordance with an embodiment of the present invention, the plurality of machine tool detection sub-systems of the integrated system for customized machine tool detection at least comprises a lubricant oil detection sub-system, wherein the lubricant oil detection sub-system is used for detection detecting a lubricant oil and has the detection information includes an oil level value, a humidity index, and a temperature index.

In accordance with an embodiment of the present invention, the plurality of machine tool detection sub-systems of the integrated system for customized machine tool detection at least comprises a motor detection sub-system, wherein the motor detection sub-system is used for detection detecting a motor and has the detection information includes a motor rotational speed value and a motor vibration speed value.

As mentioned above, the present invention uses the communication module, the database, the display module, the operation interface, and the integrated module to detect the working machine tool. In comparison with the prior art, the present invention chooses from the machine tool detection sub-systems based on the detection request of the working machine tool and defines the customized machine tool detection system to detect the working machine tool in real time such that the functions of sharing and customization can be achieved. Moreover, the present invention uses the conversion module, the added communication module and the added detection sub-system to have the added detection sub-system using the second communication protocol interface interfacing with the database for the user to choose and use. In addition, because the machine tool detection sub-system or the added detection sub-system can be chosen by the user in the present invention, the drawbacks of prior art including using human power, using human experience, scheduled inspection, maintenance until damage happens and other problems derived thereof can be resolved, and the functions of real-time detection, active detection, beforehand prediction of machine tool condition can be achieved to prevent the conditions of unexpected stop of production line and maintenance until damage happens or the defective product is produced, such that the service life of the machine tool can be enhanced and the unnecessary replacement of the machine tool can be prevented by using science with the accumulated real-time detection information.

### BRIEF DESCRIPTION OF THE DRAWINGS

FIG. 1 is a block diagram showing an integrated system for customized machine tool detection provided in accordance with a preferred embodiment of the present invention;

FIG. 2 is a schematic view showing a machine tool detection sub-system provided in accordance with a preferred embodiment of the present invention; and

FIG. 3 is a schematic view showing another machine tool detection sub-system provided in accordance with a preferred embodiment of the present invention.

### DETAILED DESCRIPTION OF THE EMBODIMENTS

More detailed descriptions of specific embodiments of the disclosure are provided below with reference to the schematic diagrams. The advantages and features of the disclosure are described more clearly according to the following description and claims. It should be noted that all of the drawings use very simplified forms and imprecise proportions, only being used for assisting in conveniently and clearly explaining the objective of the embodiments of the disclosure.

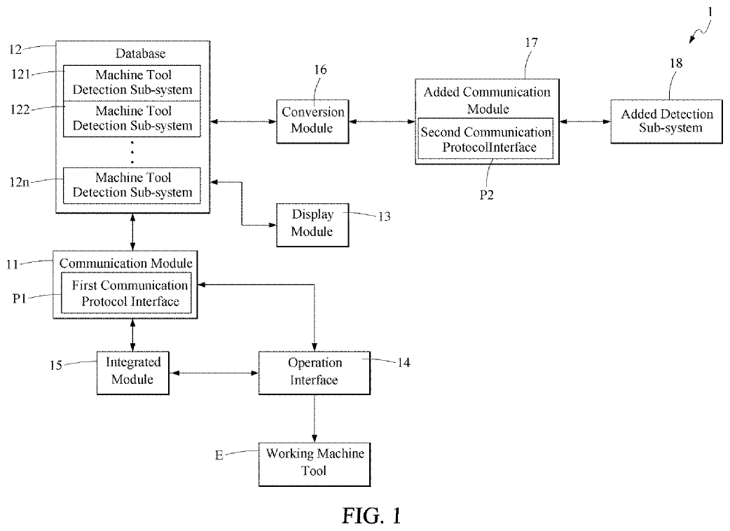

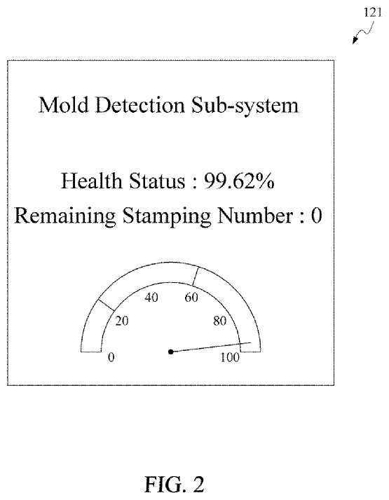

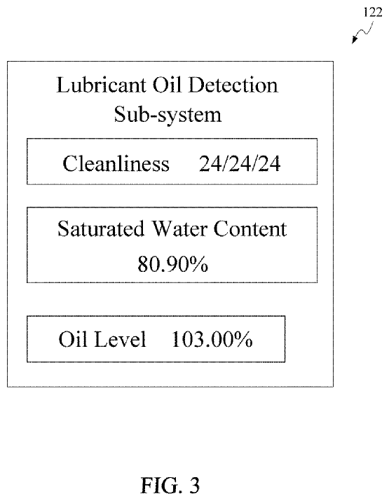

Please refer to FIGS. 1 to 3, wherein FIG. 1 is a block diagram showing an integrated system for customized machine tool detection provided in accordance with a preferred embodiment of the present invention; FIG. 2 is a schematic view showing a machine tool detection sub-system provided in accordance with a preferred embodiment of the present invention; and FIG. 3 is a schematic view showing another machine tool detection sub-system provided in accordance with a preferred embodiment of the present invention. As shown, the integrated system 1 for customized machine tool detection comprises a communication module 11, a database 12, a display module 13, an operation interface 14 and an integrated module 15.

The communication module 11 has a first communication protocol interface P1. In the present embodiment, the first communication protocol interface P1 further comprises a shared database field, but is not restricted thereto. The first communication protocol interface P1 can be a HTTP POST interface, or the first communication protocol interface P1 can be a HTTP GET interface.

The database 12 is used for storing a plurality of machine tool detection sub-systems 121, 122, 12n (three in the figure is labelled as an example) sharing the first communication protocol interface P1 and is communicated with the communication module 11. Is it noted that the number of the machine tool detection sub-systems 121, 122, 12n is plural, which may be three, seven, fifteen, etc. The three machine tool detection sub-systems 121, 122, 12n shown in the figure with dots “ ” added between the machine tool detection sub-system 122 and the machine tool detection sub-system 12n indicates the number of the machine tool detection sub-systems 1221, 122, 12n is plural.

The display module 13 is communicated with the database 12 and shows a plurality of sub-system items corresponding to the machine tool detection sub-systems 121, 122, 12n. The display module 13 can be a computer display, a cell phone display, or other modules with display function.

The operation interface 14 is communicated with the communication module 11 for a user to choose at least one of the plurality of sub-system items as at least one to-be-integrated sub-system item based on at least one detection request of a working machine tool E, wherein the at least one machine tool detection sub-system 121, 122, 12n corresponding to the at least one to-be-integrated sub-system item is defined as at least one to-be-integrated machine tool detection sub-system. The operation interface 14 can be the interface of a computer, a cell phone or other devices capable to be operated by the user.

That is, when the user chooses one of the plurality of sub-system items as the to-be-integrated sub-system item based on the detection request, the machine tool detection sub-system corresponding to the to-be-integrated sub-system, i.e., one of the machine tool detection sub-systems 121, 122, 12n, is defined as a to-be-integrated machine tool detection sub-system. When the user chooses several of the sub-system items as a plurality of to-be-integrated sub-system item based on the detection request, a plurality of machine tool detection sub-system corresponding to the plurality of to-be-integrated sub-system, i.e., several of the machine tool detection sub-systems 121, 122, . . . 12n, are defined as a plurality of to-be-integrated machine tool detection sub-system.

The integrated module 15 is communicated with the operation interface 14 for using the first communication protocol interface P1 to integrate the corresponding at least one to-be-integrated machine tool detection sub-system according to the chosen at least one to-be-integrated sub-system item as a customized machine tool detection system satisfying the detection request for detecting the working machine tool E to access a detection information.

Thus, the user may choose the adequate machine tool detection sub-systems 121, 122, . . . 12n based on the detection request of the working machine tool E to achieve the function of customization. In addition, because the machine tool detection sub-systems 121, 122, . . . 12n can be shared by using the first communication protocol interface P1, the machine tool detection sub-systems 121, 122, . . . 12n may have the present invention achieve the function of sharing.

In the present embodiment, the integrated system 1 for customized machine tool detection further comprises a conversion module 16, an added communication module 17, and an added detection sub-system 18.

The added communication module 17 has a second communication protocol interface P2 and is communicated with the added detection sub-system 18, wherein the second communication protocol interface P2 is different from the first communication protocol interface P1.

The conversion module 16 is communicated with the added communication module 17 and the database 12 so as have the added detection sub-system 18 using the second communication protocol interface P2 interfacing with the database 12. Therefore, the user may choose not to use the first communication protocol interface P1, but to use the added communication sub-system 18 using the second communication protocol interface P2 in accordance with the present embodiment as an example. The conversion module 16 can be a translator or other modules with conversion capability to have the added detection sub-system 18 using the second communication protocol interface P2 which is different from the first communication protocol interface P1 interfacing with the database 12. In the present embodiment, the second communication protocol interface P2 is a MODBUS TCP interface but is not restricted thereto. The second communication protocol interface P2 just needs to be different from the first communication protocol interface P1.

As shown in FIG. 2, the machine tool detection sub-system 121 is a mold detection sub-system for detecting the working machine tool E to access a detection information. Wherein the detection information comprises health status, remaining stamping number, etc.

Please also refer to the following Table 1. Table 1 is a schematic table showing the detection information of the mold detection sub-system. The mold detection sub-system may transmit data to the database 12 every detection cycle. For the following example, vrms1, i.e., the mold vibration acceleration value accessed by one of the vibration detectors in the mold, is transmitted. Because the mold may have a plurality of vibration detectors to access a plurality of mold vibration acceleration values from different locations, different axes, etc., a number is added at the end of the mold vibration acceleration value to distinguish the mold vibration acceleration values. The other terms are explained as below: createTime indicates time of detection, deviceCode indicates code number of device, channelCode indicates code number of channel, vrms indicates detection value. The unit for detection time is ms, code of device and code of channel do not have physical units, the unit for vrms is acceleration m/s², detection frequency of 10 Hz indicates collecting 10 records of data within a detection period of one second, data frequency of 1 Hz indicate once pre second and thus 10 records are transmitted per second.

TABLE 1

| data name | vrms1 | interface | HTTP POST | |
|---|---|---|---|---|
| database field | createTime | deviceCode | channelCode | vrms |
| data type | TimStamp | String | String | Float |
| data unit | ms | N/A | N/A | m/s² |
| detection frequency | 10 Hz | 10 Hz | 10 Hz | 10 Hz |
| data frequency | 1 Hz | 1 Hz | 1 Hz | 1 Hz |
| with threshold of | No | No | No | No |
| not | | | | |
| upper threshold | 0 | 0 | 0 | 0 |
| lower threshold | 0 | 0 | 0 | 0 |

In addition, because vrms does not have a threshold, there has no so-called upper threshold or lower threshold. The aforementioned table is only a schematically showing of one data among the detection information, and the detection information of the mold detection sub-system usually includes other data, for example, other vrms, mold health confidence index (estimated by using confidence index), etc. Generally speaking, based on the of the variation curves of the vibration detection values of a new or just repaired mold and the vibration detection values of the mold which is determined to be repaired after long time stamping, the most approximate curve equation is found through mathematical operations so as to predict the degree of mold wear, and quantifying the aforementioned degree of wear into a numerical value, i.e., the confidence value index (CV index). Such technology is well known in the art, and thus is described briefly.

As shown in FIG. 3, the machine tool detection sub-system 122 is a lubricant oil detection sub-system for detecting the working machine tool E to access a detection information. Wherein the detection information comprises cleanliness, saturated water content, oil level, etc.

The lubricant oil detection sub-system is used for detecting a lubricant oil to have the detection information includes an oil level value, a humidity index, and a temperature index. Please also refer to the following Table 2. Table 2 is a schematic table showing the detection information of the lubricant oil detection sub-system, wherein most of the content can be understood from Table 1 and thus is not repeated here. The major difference is, the oil level value of the lubricant oil detection sub-system has a threshold, and thus the upper threshold and the lower threshold exist shown in Table 2.

TABLE 2

| data name | oilLevel | interface | HTTP POST | |
|---|---|---|---|---|
| database field | createTime | deviceCode | channelCode | level |
| data type | TimStamp | String | String | Float |
| data unit | ms | N/A | N/A | % |
| detection frequency | 0.2 Hz | 0.2 Hz | 0.2 Hz | 0.2 Hz |
| data frequency | 0.2 Hz | 0.2 Hz | 0.2 Hz | 0.2 Hz |
| with threshold of | No | No | No | Yes |
| not | | | | |
| upper threshold | 0 | 0 | 0 | 95% |
| lower threshold | 0 | 0 | 0 | 40% |

The aforementioned table is only a schematically showing of one data among the detection information, and the detection information of the lubricant oil detection sub-system usually includes other data, e.g. humidity index, temperature index, etc.

In addition, the machine tool detection sub-system of the present invention may include a motor detection sub-system for detecting a motor and have the detection information comprises a motor rotational speed value and a motor vibration speed value.

The working machine tool E may be a stamping tool for example, which at least includes the components such as a bed, a mold, a driving assembly, and lubricant oil. Thus, the user may choose the aforementioned machine tool detection sub-system 121, the aforementioned machine tool detection sub-system 122 and other machine tool detection sub-systems corresponding to the bed and the driving assembly to define a customized machine tool detection system satisfying the detection need when the working machine tool E is a stamping tool.

After the user choosing and defining the customized machine tool detection system, the database 12 may store the customized machine tool detection system defined by the user. Therefore, the other user may use the customized machine tool detection system as a reference or follow the customized machine tool detection system. In addition, the same user may keep following the customized machine tool detection system in the next time so as to achieve the function of expanding sharing.

In the present embodiment, the added detection sub-system 18 can be an added motor detection sub-system. Please also refer to the following Table 3. Table 3 is a schematic table showing the detection information of the added motor detection sub-system.

TABLE 3

| | | | | |
|---|---|---|---|---|
| data name | vrms1 | interface | MODBUS | |
| | | | TCP | |
| database | createTime | deviceCode | channelCode | rms |
| field | | | | |
| access | fill Query | fill 0 | fill 1 | ask registers |
| way | time | | | 0x30011 and |
| | | | | 0x30012 |
| | | | | through the |
| | | | | MODBUS TCP |
| | | | | interface |
| data unit | ms | N/A | N/A | m/s² |
| detection | 1 Hz | 1 Hz | 1 Hz | ask per second |
| frequency | | | | |
| data | 1 Hz | 1 Hz | 1 Hz | response to |
| frequency | | | | database through |
| | | | | HTTP POST |
| | | | | interface per |
| | | | | second |

Although the added detection sub-system 18 cannot support the first communication protocol interface P1, the second communication protocol interface P2 of the added communication module 17 and the conversion module 16 may be used to have the added detection sub-system 18 interfacing with the database 12 for the users to choose and share.

In conclusion, the present invention uses the communication module, the database, the display module, the operation interface, and the integrated module to detect the working machine tool. In comparison with the prior art, the present invention chooses from the machine tool detection sub-systems based on the detection request of the working machine tool and defines the customized machine tool detection system to detect the working machine tool in real time such that the functions of sharing and customization can be achieved. Moreover, the present invention uses the conversion module, the added communication module, and the added detection sub-system to have the added detection sub-system using the second communication protocol interface interfacing with the database for the user to choose and use. In addition, because the machine tool detection sub-system or the added detection sub-system can be chosen by the user in the present invention, the drawbacks of prior art including using human power, using human experience, scheduled inspection, maintenance until damage and the other problems derived thereof can be resolved, and the functions of real-time detection, active detection, beforehand prediction of machine tool condition can be achieved to prevent the conditions of unexpected stop of production line and maintenance until damage happens or the defective product is produced, such that the service life of the machine tool can be enhanced and the unnecessary replacement of the machine tool can be prevented by using science with the accumulated real-time detection information.

The above is merely exemplary embodiments of the disclosure, and does not constitute any limitation on the disclosure. The disclosure is implemented in any appropriate form. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. An integrated system for customized machine tool detection comprising:
a communication module, having a first communication protocol interface;
a database, used for storing a plurality of machine tool detection sub-systems sharing the first communication protocol interface, and communicated with the communication module;
a display module, communicated with the database and showing a plurality of sub-system items corresponding to the plurality of machine tool detection sub-systems;
an operation interface, communicated with the communication module, for a user to choose at least one of the plurality of sub-system items as at least one to-be-integrated sub-system item based on at least one detection request of a working machine tool, wherein the at least one machine tool detection sub-system corresponding to the at least one to-be-integrated sub-system item is defined as at least one to-be-integrated machine tool detection sub-system; and
an integrated module, communicated with the operation interface for using the first communication protocol interface to integrate the corresponding at least one to-be-integrated machine tool detection sub-system according to the chosen at least one to-be-integrated sub-system item as a customized machine tool detection system satisfying the at least one detection request for detecting the working machine tool to access a detection information.

2. The integrated system for customized machine tool detection of claim 1, wherein the first communication protocol interface further comprises a share database field.

3. The integrated system for customized machine tool detection of claim 1, wherein the first communication protocol interface is a HTTP POST interface.

4. The integrated system for customized machine tool detection of claim 1, wherein the first communication protocol interface is a HTTP GET interface.

5. The integrated system for customized machine tool detection of claim 1, further comprising:
an added detection sub-system;
an added communication module, having a second communication protocol interface which is different from the first communication protocol interface, and communicated with the added detection sub-system; and
a conversion module, communicated with the added communication module and the database, for having the added detection sub-system using the second communication protocol interfacing with the database.

6. The integrated system for customized machine tool detection of claim 5, wherein the conversion module is a translator.

7. The integrated system for customized machine tool detection of claim 5, wherein the second communication protocol is a MODBUS TCP interface.

8. The integrated system for customized machine tool detection of claim 1, wherein the plurality of machine tool detection sub-systems at least comprises a mold detection sub-system, wherein the mold detection sub-system is used for detecting a mold and has the detection information includes a mold vibration acceleration value.

9. The integrated system for customized machine tool detection of claim 1, wherein the plurality of machine tool detection sub-systems at least comprises a lubricant oil detection sub-system, wherein the lubricant oil detection sub-system is used for detecting a lubricant oil and has the detection information includes an oil level value, a humidity index, and a temperature index.

10. The integrated system for customized machine tool detection of claim 1, wherein the plurality of machine tool detection sub-systems at least comprises a motor detection sub-system, wherein the motor detection sub-system is used for detecting a motor and has the detection information includes a motor rotational speed value and a motor vibration speed value.
